(19) United States
(12) Patent Application Publication
(10) Pub. No.: US 2026/0369227 A1
(43) Pub. Date: Nov. 19, 2026

(54) DISPLAY APPARATUS, AND PIXEL CIRCUIT AND DRIVING METHOD THEREFOR

(71) Applicants: Chongqing BOE Display Technology Co., Ltd., Chongqing (CN); BOE TECHNOLOGY GROUP CO., LTD., Beijing (CN)

(72) Inventor: Lei ZHU, Beijing (CN)

(73) Assignees: Chongqing BOE Display Technology Co., Ltd., Chongqing (CN); BOE TECHNOLOGY GROUP CO., LTD., Beijing (CN)

(21) Appl. No.: 19/471,120

(22) PCT Filed: Mar. 29, 2024
(86) PCT No.: PCT/CN2024/084939

§ 371 Date: Sep. 30, 2025

(30) Foreign Application Priority Data
Mar. 31, 2023 (WO) PCT/CN2023/085450
Mar. 28, 2024 (CN) 202410370909.X

(51) Int. Cl. G09G 3/3233

(52) U.S. Cl. CPC G09G 3/3233; G09G 2300/0819; G09G 2300/0842; G09G 2300/0861; G09G 2310/08; G09G 2330/02

(57) ABSTRACT

A pixel circuit includes: a first storage sub-circuit, a driving sub-circuit, a light-emitting control sub-circuit, a second storage sub-circuit, a data writing sub-circuit, and a compensation sub-circuit. The first storage sub-circuit is connected between a first node and a second node. The driving sub-circuit is connected to the first node, a third node, and a fourth node; the third node being connected to a first power supply terminal. The light-emitting control sub-circuit is connected to the fourth node. The second storage sub-circuit is connected to the first node and configured to store a potential of the first node. The data writing sub-circuit is connected to the second node. The compensation sub-circuit is connected to a first scanning signal terminal, the first node and the third node fourth node.

### CROSS-REFERENCE TO RELATED APPLICATIONS

The present application is a national phase entry under 35 USC 371 of International Patent Application No. PCT/CN2024/084939, filed on Mar. 29, 2024, which claims priority to International Patent Application No. PCT/CN2023/085450, filed on Mar. 31, 2023, and Chinese Patent Application No. 202410370909.X, filed on Mar. 28, 2024, each are incorporated herein by reference in their entirety.

### TECHNICAL FIELD

The present disclosure relates to the field of display technologies, and in particular, to a display apparatus, a pixel circuit and a driving method therefor.

### BACKGROUND

Organic light-emitting diode displays are a new generation of display products following liquid crystal displays. The organic light-emitting diode displays are gradually becoming the mainstream and leader in the display field due to their characteristics such as good color saturation, fast response speed, foldability, and thinness and lightness. The organic light-emitting diode displays still need further improvement.

### SUMMARY

The present disclosure aims to provide a display apparatus, a pixel circuit and a driving method therefor.

According to an aspect of the present disclosure, a pixel circuit is provided, and is used for a display apparatus, the pixel circuit includes:
a first storage sub-circuit connected between a first node and a second node;
a driving sub-circuit connected to the first node, a third node, and a fourth node, and used to control connection or disconnection between the third node and the fourth node under control of the first node; the third node being connected to a first power supply terminal;
a light-emitting control sub-circuit connected to the fourth node, and configured to connected to a first electrode of a sub-pixel; the light-emitting control sub-circuit being used to control connection or disconnection between the fourth node and the first electrode of the sub-pixel;
a second storage sub-circuit connected to the first node and used to store a potential of the first node;
a data writing sub-circuit connected to the second node and used to input a voltage to the second node; and
a compensation sub-circuit connected to a first scanning signal terminal and the first node.

The compensation sub-circuit is further connected to the third node and is used to control connection or disconnection between the first node and the third node under control of the first scanning signal terminal; or
the compensation sub-circuit is further connected to the fourth node and is used to control connection or disconnection between the first node and the fourth node under the control of the first scanning signal terminal.

Further, in a display frame of a display apparatus, a driving process of the pixel circuit includes a compensation phase and a data writing phase.

In the compensation phase, the compensation sub-circuit is configured to control connection or disconnection between the first node and the third node or fourth node, and the data writing sub-circuit is configured to input a first voltage to the second node.

In the data writing phase, the data writing sub-circuit is configured to input a second voltage to the second node.

Further, the data writing phase includes a first period and a second period.

In the first period, the compensation sub-circuit is configured to control the first node to be connected to the third node or fourth node, and the data writing sub-circuit is configured to input the second voltage to the second node.

In the second period, the compensation sub-circuit is configured to control the first node to be disconnected from the third node or fourth node, and the data writing sub-circuit is configured to input the second voltage to the second node.

Further, the pixel circuit further includes:
a first reset sub-circuit connected to a first reset signal terminal, a first initialization signal terminal and the first node, and is used to control connection or disconnection between the first initialization signal terminal and the first node under control of the first reset signal terminal.

Further, the first reset sub-circuit includes:
a first reset transistor; a control electrode of the first reset transistor is connected to the first reset signal terminal, a first electrode of the first reset transistor is connected to the first initialization signal terminal, and a second electrode of the first reset transistor is connected to the first node.

Further, the pixel circuit further includes:
a second reset sub-circuit connected to the first scanning signal terminal, a second initialization signal terminal and configured to be connected to the first electrode of the sub-pixel; the second reset sub-circuit being used to control connection or disconnection between the second initialization signal terminal and the first electrode of the sub-pixel under the control of the first scanning signal terminal.

The second reset sub-circuit includes:
a second reset transistor; a control electrode of the second reset transistor is connected to the first scanning signal terminal, a first electrode of the second reset transistor is connected to the second initialization signal terminal, and a second electrode of the second reset transistor is configured to be connected to a second electrode of the sub-pixel.

Further, the data writing sub-circuit includes:
a data writing transistor; a control electrode of the data writing transistor is connected to a second scanning signal terminal, a first electrode of the data writing transistor is connected to a data signal terminal, and a second electrode of the data writing transistor is connected to the second node.

Further, the driving sub-circuit includes:
a driving transistor, a control electrode of the driving transistor is connected to the first node, a first electrode of the driving transistor is connected to the third node, and a second electrode of the driving transistor is connected to the fourth node.

Further, the compensation sub-circuit includes:
a compensation transistor; a control electrode of the compensation transistor is connected to the first scanning signal terminal, a first electrode of the compensation transistor is connected to the third node or fourth node, and a second electrode of the compensation transistor is connected to the first node.

Further, the light-emitting control sub-circuit is further connected to the first power supply terminal and the third node, and is used to control connection or disconnection between the first power supply terminal and the third node.

Further, the light-emitting control sub-circuit includes a first light-emitting control transistor connected between the first power supply terminal and the third node in series.

Further, the light-emitting control sub-circuit includes a second light-emitting control transistor connected between the fourth node and the first electrode of the sub-pixel in series.

Further, the first storage sub-circuit includes a first capacitor; the second storage sub-circuit includes a second capacitor.

Further, the first reset transistor is an oxide transistor.

Further, the compensation transistor is an oxide transistor.

Further, the data writing transistor is an oxide transistor.

Further, the pixel circuit further includes a second reset sub-circuit connected to the first scanning signal terminal, and a second initialization signal terminal, and is configured to be connected to the first electrode of the sub-pixel; the second reset sub-circuit being used to control connection or disconnection between the second initialization signal terminal and the first electrode of the sub-pixel under the control of the first scanning signal terminal within a display frame of the display apparatus.

A driving process for the pixel circuit includes:

an initialization phase, the initialization phase including three periods.

In a first period: the light-emitting control sub-circuit remains in an on state, and the first reset sub-circuit, the data writing sub-circuit, the compensation sub-circuit, and the second reset sub-circuit are turned off.

In a second period: the first reset sub-circuit and the data writing sub-circuit are turned on, the compensation sub-circuit, the light-emitting control sub-circuit, and the second reset sub-circuit are turned off, and the data writing sub-circuit is configured to input the voltage to the second node.

In a third period: the data writing sub-circuit is turned on, the first reset sub-circuit, the compensation sub-circuit, the light-emitting control sub-circuit, and the second reset sub-circuit are turned off, and voltages of the first node and the second node remain unchanged.

Further, the pixel circuit further includes a second reset sub-circuit connected to the first scanning signal terminal, and the second initialization signal terminal, and configured to be connected to the first electrode of the sub-pixel; the second reset sub-circuit being used to control connection to or disconnection between the second initialization signal terminal and the first electrode of the subpixel under the control of the first scanning signal terminal within a display frame of the display apparatus.

A driving process for the pixel circuit includes:

an initialization phase, the initialization phase including three periods.

In a first period: the first reset sub-circuit and the light-emitting control sub-circuit remains in an on state, the data writing sub-circuit, the compensation sub-circuit, and the second reset sub-circuit are turned off, and the first reset sub-circuit is configured to reset the first node.

In a second period: the first reset sub-circuit, the data writing sub-circuit, the compensation sub-circuit, and the second reset sub-circuit are turned on, the light-emitting control sub-circuit is turned off, the data writing sub-circuit is configured to input the voltage to the second node, and the second reset sub-circuit is configured to reset the first electrode of the sub-pixel.

In a third period: the compensation sub-circuit and the second reset sub-circuit are turned on, and the first reset sub-circuit and the light-emitting control sub-circuit are turned off.

According to another aspect of the present disclosure, a driving method for a pixel circuit is provided. The driving method is used for the pixel circuit, and the driving method includes:
enabling the driving sub-circuit to control the connection or disconnection between the third node and the fourth node under the control of the first node;
enabling the light-emitting control sub-circuit to control the connection or disconnection between the fourth node and the first electrode of the sub-pixel;
enabling the second storage sub-circuit to store the potential of the first node;
enabling the data writing sub-circuit to input the voltage to the second node; and
enabling the compensation sub-circuit to control the connection or disconnection between the first node and the third node under the control of the first scanning signal terminal, or enabling the compensation sub-circuit to control the connection or disconnection between the first node and the fourth node under the control of the first scanning signal terminal.

According to an aspect of the present disclosure, a display apparatus is provided, which includes the pixel circuit and the sub-pixel connected to the pixel circuit.

### BRIEF DESCRIPTION OF THE DRAWINGS

FIG. 1 is a structural diagram of a pixel circuit, in accordance with some embodiments of the present disclosure.

FIG. 2 is a circuit diagram of a pixel circuit, in accordance with some embodiments of the present disclosure.

FIGS. 3(a), 3(b), and 3(c) are each an operation timing diagram of the pixel circuit shown in FIG. 2.

FIG. 4 is a circuit diagram of another pixel circuit, in accordance with some embodiments of the present disclosure.

FIG. 5 is an operation timing diagram of the pixel circuit shown in FIG. 4.

FIG. 6 is a circuit diagram of yet another pixel circuit, in accordance with some embodiments of the present disclosure.

FIG. 7 is an operation timing diagram of the pixel circuit shown in FIG. 6.

FIG. 8 is a circuit diagram of yet another pixel circuit, in accordance with some embodiments of the present disclosure.

FIG. 9 is an operation timing diagram of the pixel circuit shown in FIG. 8.

FIG. 10 is a schematic diagram showing an arrangement of sub-pixels in a display apparatus, in accordance with some embodiments of the present disclosure.

FIG. 11 is a circuit diagram of yet another pixel circuit, in accordance with some embodiments of the present disclosure.

FIGS. 12(a) and 12(b) are each an operation timing diagram of the pixel circuit shown in FIG. 11.

FIG. 13 is a circuit diagram of yet another pixel circuit, in accordance with some embodiments of the present disclosure.

FIGS. 14(a) and 14(b) are each an operation timing diagram of the pixel circuit shown in FIG. 13.

FIG. 15 is a circuit diagram of yet another pixel circuit, in accordance with some embodiments of the present disclosure.

FIG. 16 is an operation timing diagram of the pixel circuit shown in FIG. 15.

FIG. 17 is a circuit diagram of yet another pixel circuit, in accordance with some embodiments of the present disclosure.

FIGS. 18(a) and 18(b) are each an operation timing diagram of the pixel circuit shown in FIG. 17.

FIG. 19 is a circuit diagram of yet another pixel circuit, in accordance with some embodiments of the present disclosure.

FIGS. 20(a) and 20(b) are each an operation timing diagram of the pixel circuit shown in FIG. 19.

FIG. 21 is a circuit diagram of yet another pixel circuit, in accordance with some embodiments of the present disclosure.

FIG. 22 is an operation timing diagram of the pixel circuit shown in FIG. 21.

Explanation of reference signs: 1. Data writing sub-circuit; 2. Compensation sub-circuit; 3. First reset sub-circuit; 4. Second reset sub-circuit; 5. Light-emitting control sub-circuit; 6. Driving sub-circuit; 7. First storage sub-circuit; 8. Sub-pixel row; 9. Sub-pixel column; 10. Second storage sub-circuit; EM1(n), First light-emitting control signal terminal; EM2(n), Second light-emitting control signal terminal; Gate1(n−1), First reset signal terminal; Gate1(n), First scanning signal terminal; Gate2(n), Second scanning signal terminal; Init1, First initialization signal terminal; Init2, Second initialization signal terminal; VDD, First power supply terminal; VSS, Second power supply terminal; C1, First capacitor; C2, Second capacitor; Data, Data signal terminal; L0, Sub-pixel; EM(n), Light-emitting control signal terminal; EM(n−1), Auxiliary control signal terminal; T1, First reset transistor; T2, Compensation transistor; T3, Driving transistor; T4, Data writing transistor; T5, First light-emitting control transistor; T6, Second light-emitting control transistor; T7, Second reset transistor; N1, First node; N2, Second node; N3, Third node; N4, Fourth node; Gate2(n−1), Third scanning signal terminal; Gate3(n), Second reset signal terminal.

### DETAILED DESCRIPTION

Reference will now be made in detail to exemplary embodiments, examples of which are illustrated in the accompanying drawings. When the following description refers to the drawings, unless otherwise indicated, the same numerals in different drawings represent the same or similar elements. The embodiments described in the following exemplary embodiments do not represent all embodiments consistent with the present disclosure. On the contrary, they are merely examples of apparatuses consistent with some aspects of the present disclosure as recited in the claims.

The terms used in the present disclosure is for the purpose of describing particular embodiments only and is not intended to be limiting of the present disclosure. Unless otherwise defined, technical terms or scientific terms used in the present disclosure shall be understood as ordinary meanings by a person of ordinary skill in the art to which the present disclosure pertains. Terms such as “first”, “second” and similar words used in the description and the claims of the present disclosure are not intended to mean any order, quantity or importance, and are merely used to distinguish different components. Likewise, the terms “a” or “an” and the like do not denote a limitation of quantity, but rather denote the presence of at least one. “Multiple” or “several” means two or more. Unless otherwise indicated, terms such as “front”, “back”, “lower”, and/or “upper” are used for convenience of description only and are not intended to limit the subject matter to a position or spatial orientation. The terms “include” or “comprise” and similar words are intended to mean that an element or object that precedes the terms includes element(s) or object(s) listed after the terms and equivalents thereof, but other elements or objects are not excluded. In the description of some embodiments, the terms “connected” and “connection” and derivatives thereof may be used. For example, the term “connected” may be used in the description of some embodiments to indicate that two or more elements are in direct physical or electrical contact with each other. For another example, the term “connection” may be used in the description of some embodiments to indicate that two or more components are in direct physical or electrical contact. However, the term “connected” may mean that two or more components are not in direct contact with each other, but still cooperate or interact with each other. As used in the present disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items.

The transistors used in the present disclosure may all be triodes, thin film transistors, field effect transistors or other switching devices with same characteristics. In the embodiments of the present disclosure, in order to distinguish two electrodes of the transistor except a control electrode, one electrode of the two electrodes is referred to as a first electrode, and the other electrode is referred to as a second electrode.

In actual operation, in a case where the transistor is a triode, a control electrode may be a base, the first electrode may be a collector, and the second electrode may be an emitter; alternatively, the control electrode may be a base, the first electrode may be an emitter, and the second electrode may be a collector.

In actual operation, in a case where the transistor is a thin film transistor or a field effect transistor, the control electrode may be a gate, the first electrode may be a drain, and the second electrode may be a source; alternatively, the control electrode may be a gate, the first electrode may be a source, and the second electrode may be a drain. In a case where the transistor is a thin film transistor, the thin film transistor may be an N-type thin film transistor or a P-type thin film transistor.

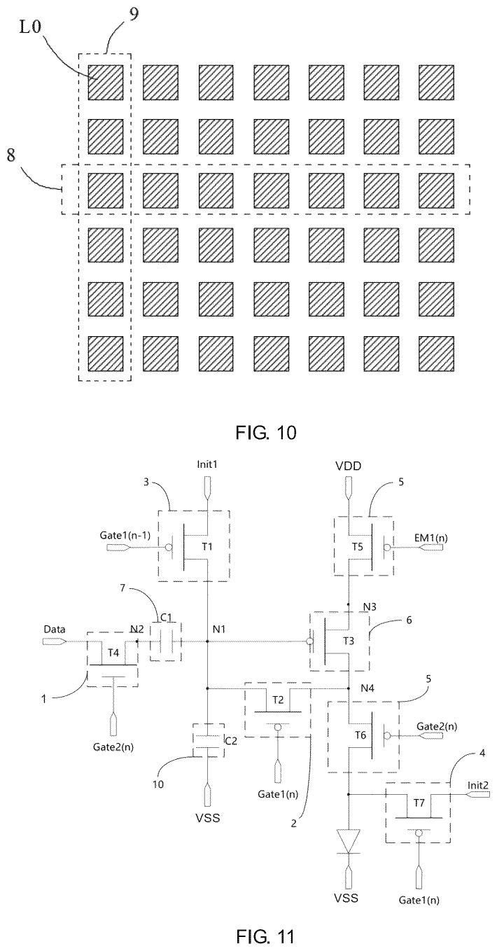

Embodiments of the present disclosure provide a pixel circuit. The pixel circuit is used for a display apparatus. As shown in FIG. 10, the display apparatus may include a plurality of sub-pixels L0 and a plurality of pixel circuits, and the plurality of pixel circuits are connected to the plurality of sub-pixels L0 in a one-to-one correspondence. The plurality of sub-pixels L0 includes a plurality of first sub-pixels, a plurality of second sub-pixels and a plurality of third sub-pixels. The plurality of first sub-pixels, the plurality of second sub-pixels and the plurality of third sub-pixels emit different light-emitting colors. For example, the first sub-pixels emit red light, the second sub-pixels emit green light, and the third sub-pixels emit blue light. The plurality of sub-pixels L0 may be distributed in an array, and constitute a plurality of sub-pixel rows 8 and a plurality of sub-pixel columns 9. A sub-pixel row 8 includes a plurality of sub-pixels L0 distributed in a row direction, and a sub-pixel column 9 includes a plurality of sub-pixels L0 distributed in a column direction. A first sub-pixel, a second sub-pixel, and a third sub-pixel constitute a pixel. The plurality of sub-pixels L0 may form a plurality of pixels.

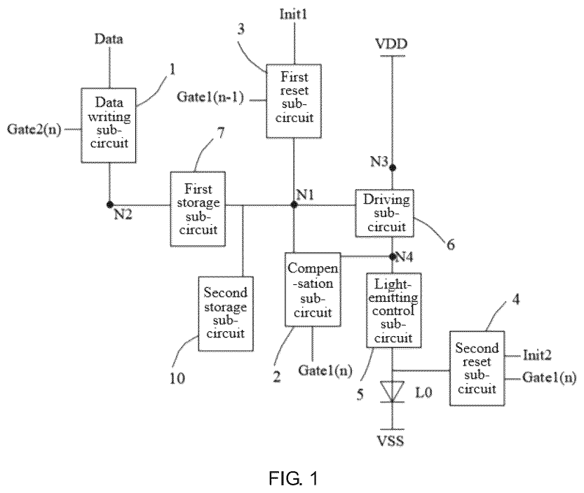

As shown in FIG. 1, the pixel circuit includes a first storage sub-circuit 7, a driving sub-circuit 6, a first light-emitting control sub-circuit 5, a second storage sub-circuit 10, a data writing sub-circuit 1, a compensation sub-circuit 2.

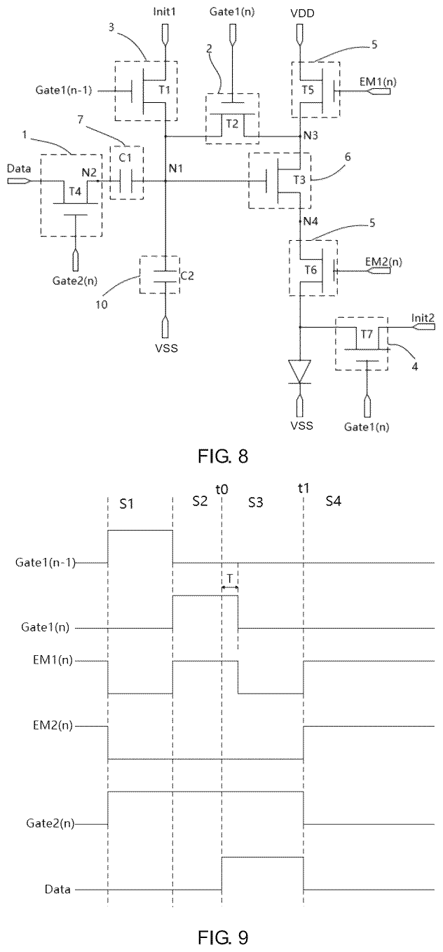

The first storage sub-circuit 7 is connected between a first node N1 and a second node N2. The driving sub-circuit 6 is connected to the first node N1, a third node N3 and a fourth node N4, and is used to control connection or disconnection between the third node N3 and the fourth node N4 under a control of the first node N1. The third node N3 is connected to a first power supply terminal VDD. The light-emitting control sub-circuit 5 is connected to the fourth node N4 and a first electrode of the sub-pixel L0, and is used to control connection or disconnection between the fourth node N4 and the first electrode of the sub-pixel L0. The second storage sub-circuit 10 is connected to the first node N1, and is used to store a potential of the first node N1. The data writing sub-circuit 1 is connected to the second node N2, and is used to input a voltage to the second node N2. The compensation sub-circuit 2 is electrically connected to a first scanning signal terminal Gate1(n) and the first node N1. The compensation sub-circuit 2 is further connected to the third node N3 (as shown in FIG. 8), and is used to control connection or disconnection of the first node N1 and the third node N3 under a control of the first scanning signal terminal Gate1(n). Alternatively, the compensation sub-circuit 2 is further connected to the fourth node N4, and is used to control connection or disconnection of the first node N1 and the fourth node N4 under the control of the first scanning signal terminal Gate1(n).

For the pixel circuit in the embodiments of the present disclosure, during a driving process, the driving sub-circuit 6 controls the third node N3 to be connected to the fourth node N4, and the compensation sub-circuit 2 controls the first node N1 to be connected to the third node N3 or the fourth node N4. Since the third node N3 is connected to the first power supply terminal VDD, the first node N1 may be charged by the first power supply terminal VDD to compensate for a threshold voltage of the driving sub-circuit 6. Thus, the problem of poor display effect caused by different threshold voltages may be solved, thereby improving the display effect.

Various parts of the pixel circuit according to the embodiments of the present disclosure will be described in detail below.

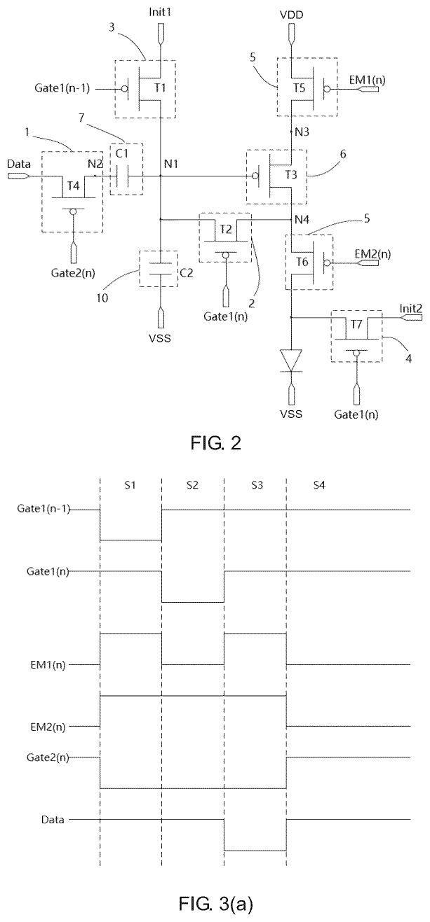

As shown in FIGS. 1 and 2, the first storage sub-circuit 7 is connected between a first node N1 and a second node N2. For example, the first storage sub-circuit 7 may include a first capacitor C1. A first plate of the first capacitor C1 is connected to the first node N1, and a second plate of the first capacitor C1 is connected to the second node N2.

As shown in FIGS. 1 and 2, the driving sub-circuit 6 is connected to the first node N1, the third node N3 and the fourth node N4, and is used to control connection or disconnection between the third node N3 and the fourth node N4 under the control of the first node N1. For example, the driving sub-circuit 6 includes a driving transistor T3; a control electrode of the driving transistor T3 is electrically connected to the first node N1, a first electrode of the driving transistor T3 is electrically connected to the third node N3, and a second electrode of the driving transistor T3 is electrically connected to the fourth node N4. The third node N3 may be connected to the first power supply terminal VDD.

As shown in FIGS. 1 and 2, the data writing sub-circuit 1 is connected to the second node N2, and is used to input a voltage to the second node N2. For example, the data writing sub-circuit 1 includes a data writing transistor T4; a control electrode of the data writing transistor T4 is electrically connected to a second scanning signal terminal Gate2(n), a first electrode of the data writing transistor T4 is electrically connected to a data signal terminal Date, and a second electrode of the data writing transistor T4 is electrically connected to the second node N2. For multiple pixel circuits connected to multiple sub-pixels L0 in a sub-pixel row 8 in one-to-one correspondence, the second scanning signal terminals Gate2(n) connected to the data writing sub-circuits 1 of all the pixel circuits may be connected to a same signal line. For two pixel circuits connected to two sub-pixels L0 located in different sub-pixel rows 8 in a one-to-one correspondence, the second scanning signal terminals Gate2(n) connected to the data writing sub-circuits 1 of the two pixel circuits are connected to different signal lines.

As shown in FIGS. 1 and 2, the pixel circuit in the embodiments of the present disclosure may further include a first reset sub-circuit 3. The first reset sub-circuit 3 is connected to a first reset signal terminal Gate1(n−1), a first initialization signal terminal Init1 and the first node N1, and is used to control connection and disconnection between the first initialization signal terminal Init1 and the first node N1 under a control of the first reset signal terminal Gate1(n−1). For example, the first reset sub-circuit 3 includes a first reset transistor T1; a control electrode of the first reset transistor T1 is connected to the first reset signal terminal Gate1(n−1), a first electrode of the first reset transistor T1 is connected to the first initial signal line Init1, and a second electrode of the first reset transistor T1 is connected to the first node N1.

As shown in FIGS. 1 and 2, the pixel circuit in the embodiments of the present disclosure may further include a second reset sub-circuit 4. The second reset sub-circuit 4 is connected to the first scanning signal terminal Gate1(n), a second initialization signal terminal Init2 and a first electrode of the sub-pixel L0, and is used to control connection or disconnection between the second initialization signal terminal Init2 and the first electrode of the sub-pixel L0 under control of the first scanning signal terminal Gate1(n). For example, the second reset sub-circuit 4 may include a second reset transistor T7. A control electrode of the second reset transistor T7 is electrically connected to the first scanning signal terminal Gate1(n), a first electrode of the second reset transistor T7 is electrically connected to the second initialization signal terminal Init2, and a second electrode of the second reset transistor T7 is electrically connected to the first electrode of the sub-pixel L0. The plurality of sub-pixel rows 8 include adjacent(n−1)-th sub-pixel row and n-th sub-pixel row, where n is greater than or equal to 2. A pixel circuit connected to a sub-pixel L0 in the (n−1)-th sub-pixel row is regarded as an (n−1)-th stage of pixel circuit, and a pixel circuit connected to a sub-pixel L0 in the n-th sub-pixel row is regarded as an n-th stage of pixel circuit. The first reset signal terminal connected to the first reset sub-circuit 3 in the n-th stage of pixel circuit and the first scanning signal terminal connected to the second reset sub-circuit 4 in the (n−1)-th stage of pixel circuit are connected to a same signal line.

As shown in FIGS. 1 and 2, the second storage sub-circuit 10 is connected to the first node N1 and is used to store the potential of the first node N1. For example, the second storage sub-circuit 10 may include a second capacitor C2. A first plate of the second capacitor C2 is electrically connected to the first node N1, and a second plate of the second capacitor C2 is electrically connected to the second power supply terminal VSS.

As shown in FIG. 8, the compensation sub-circuit 2 is connected to the first scanning signal terminal Gate1(n) and the first node N1. The compensation sub-circuit 2 is further connected to the third node N3 and is used to control connection or disconnection between the first node N1 and the third node N3 under control of the first scanning signal terminal Gate1(n). For example, the compensation sub-circuit 2 includes a compensation transistor T2. A control electrode of the compensation transistor T2 is connected to the first scanning signal line Gate1(n), a first electrode of the compensation transistor T2 is connected to the third node N3, and a second electrode of the compensation transistor T2 is connected to the first node N1.

In an embodiment, as shown in FIGS. 1 and 2, the compensation sub-circuit 2 is connected to the first scanning signal terminal Gate1(n), the first node N1 and the fourth node N4, and is used to control connection or disconnection of the first node N1 and the fourth node N4 under control of the first scanning signal terminal Gate1(n). For example, the compensation sub-circuit 2 includes a compensation transistor T2. A control electrode of the compensation transistor T2 is connected to the first scanning signal line Gate1(n), a first electrode of the compensation transistor T2 is connected to the fourth node N4, and a second electrode of the compensation transistor T2 is connected to the first node N1.

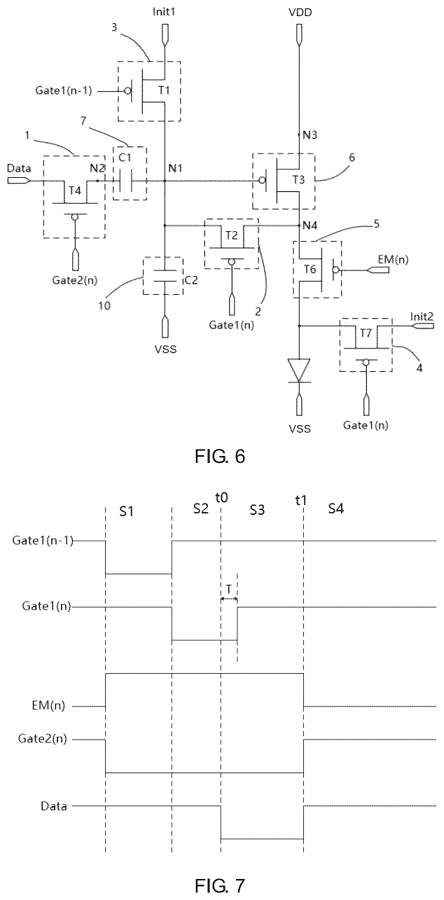

As shown in FIGS. 1 and 6, the light-emitting control sub-circuit 5 is connected to the fourth node N4 and the first electrode of the sub-pixel L0, and is used to control connection or disconnection between the fourth node N4 and the first electrode of the sub-pixel L0. For example, the light-emitting control sub-circuit 5 includes a second light-emitting control transistor T6. A control electrode of the second light-emitting control transistor T6 is connected to the light-emitting control signal terminal EM(n), a first electrode of the second light-emitting control transistor T6 is connected to the fourth node N4, and a second electrode of the second light-emitting control transistor T6 is connected to the first electrode of the sub-pixel L0. A second electrode of the sub-pixel L0 is coupled to a second power supply terminal VSS.

In another embodiment, as shown in FIG. 2, the light-emitting control sub-circuit 5 is connected to the first power supply terminal VDD, a first light-emitting control signal terminal EM1 (n), the third node N3, the fourth node N4, a second light-emitting control signal terminal EM2 (n), and the first electrode of the sub-pixel L0, and is used to control connection or disconnection between the first power supply terminal VDD and the third node N3 under control of the first light-emitting control signal terminal EM1(n), and to control connection or disconnection between the fourth node N4 and the first electrode of the sub-pixel L0 under control of the second light-emitting control signal terminal EM2(n). For example, the light-emitting control sub-circuit 5 includes a first light-emitting control transistor T5 and a second light-emitting control transistor T6. A control electrode of the first light-emitting control transistor T5 is connected to the first light-emitting control signal terminal EM1(n), and the first light-emitting control transistor T5 is connected between the first power supply terminal VDD and the third node N3 in series, that is, a first electrode of the first light-emitting control transistor T5 is connected to the first power supply terminal VDD, and a second electrode of the first light-emitting control transistor T5 is connected to the third node N3. A control electrode of the second light-emitting control transistor T6 is connected to the second light-emitting control signal terminal EM2(n), and the second light-emitting control transistor T6 is connected between the fourth node N4 and the first electrode of the sub-pixel L0 in series, that is, a first electrode of the second light-emitting control transistor T6 is connected to the fourth node N4, and a second electrode of the second light-emitting control transistor T6 is connected to the first electrode of the sub-pixel L0.

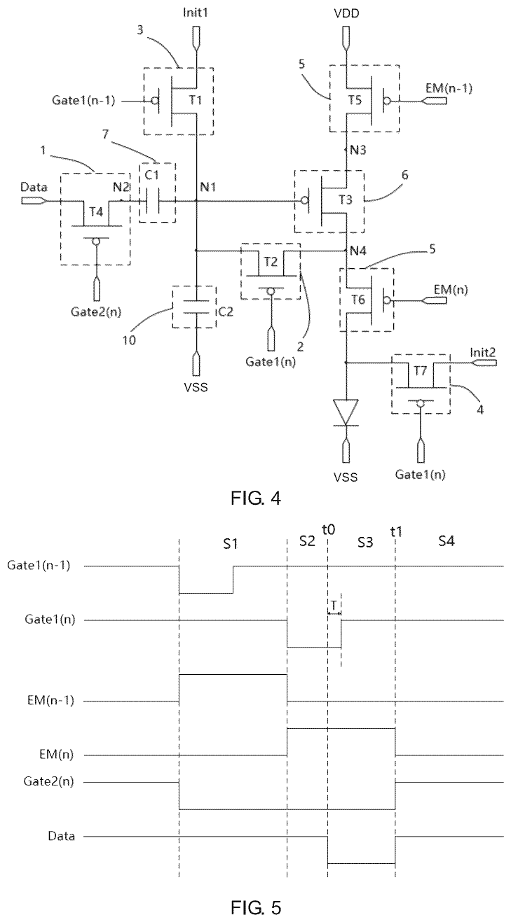

In yet another embodiment, as shown in FIG. 4, the light-emitting control sub-circuit 5 is connected to the first power supply terminal VDD, an auxiliary control signal terminal EM(n−1), the third node N3, the fourth node N4, the light-emitting control signal terminal EM(n), and the first electrode of the sub-pixel L0, and is used to control connection or disconnection between the first power supply terminal VDD and the third node N3 under control of the auxiliary control signal terminal EM(n−1), and is further used to control connection or disconnection between the fourth node N4 and the first electrode of the sub-pixel L0 under control of the light-emitting control signal terminal EM(n). For example, the light-emitting control sub-circuit 5 includes a first light-emitting control transistor T5 and a second light-emitting control transistor T6. A control electrode of the first light-emitting control transistor T5 is connected to the auxiliary control signal terminal EM(n−1), a first electrode of the first light-emitting control transistor T5 is connected to the first power supply terminal VDD, and a second electrode of the first light-emitting control transistor T5 is connected to the third node N3. A control electrode of the second light-emitting control transistor T6 is connected to the light-emitting control signal terminal EM(n), a first electrode of the second light-emitting control transistor T6 is electrically connected to the fourth node N4, and a second electrode of the second light-emitting control transistor T6 is electrically connected to the first electrode of the sub-pixel L0. The auxiliary control signal terminal connected to the light-emitting control sub-circuit 5 in the n-th stage of pixel circuit and the light-emitting control signal terminal connected to the light-emitting control sub-circuit 5 in the (n−1)-th stage of pixel circuit are connected to a same signal line.

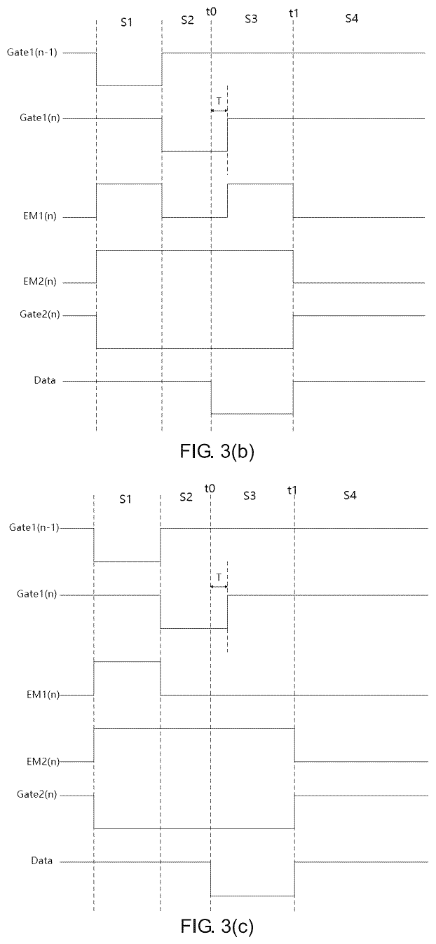

As shown in FIGS. 2 and 3(a), in a display frame of the display apparatus, the driving process of the pixel circuit includes an initialization phase S1, a compensation phase S2, a data writing phase S3 and a light-emitting phase S4. The initialization phase S1 is before the compensation phase S2, the compensation phase S2 is before the data writing phase S3, and the light-emitting phase S4 is after the data writing phase S3. In the compensation phase S2, the compensation sub-circuit 2 controls the first node N1 to be connected to the third node N3 (or the fourth node N4), and the third node N3 is connected to the first power supply terminal VDD, the first power supply terminal VDD charges the first node N1, and the data writing sub-circuit 1 inputs a first voltage to the second node N2. In the data writing phase S3, the data writing sub-circuit 1 inputs a second voltage to the second node N2. Furthermore, as shown in FIG. 3(b), the data writing phase S3 may include a first period and a second period. In the first period [from Time t0 to Time (t0+T)], the compensation sub-circuit 2 controls the first node N1 to be connected to the third node N3 (or the fourth node N4), the third node N3 is connected to the first power supply terminal VDD, and the data writing sub-circuit 1 inputs the second voltage to the second node N2. In the second period [from Time (t0+T) to Time t1], the compensation sub-circuit 2 controls the first node N1 to be disconnected from the third node N3 (or the fourth node N4), and the data writing sub-circuit 1 inputs the second voltage to the second node N2.

The operation process of the pixel circuit in FIG. 2 will be described in detail below in conjunction with the operation timing diagram of the pixel circuit shown in FIG. 3(a) by taking as an example in which the above-mentioned transistors are P-type transistors, and the operating level is a low level.

As shown in FIGS. 2 and 3(a), in the initialization phase S1, the first scanning signal terminal Gate1(n), the first light-emitting control signal terminal EM1(n) and the second light-emitting control signal terminal EM2(n) are at a high level, the first reset signal terminal Gate1(n−1) and the second scanning signal terminal Gate2(n) are at a low level, the first reset transistor T1 is turned on, and the potential VN1 of the first node N1 is written as Vinit1 by the first initialization signal terminal Init1; the data writing transistor T4 is turned on, and the data signal terminal Data inputs a first voltage (denoted as VH) to the second node N2, that is, the potential VN2 of the second node N2 is written as VH by the data signal terminal Data; the voltages at two ends of the first capacitor C1 are reset.

As shown in FIGS. 2 and 3(a), in the compensation phase S2, the first reset signal terminal Gate1(n−1) and the second light-emitting control signal terminal EM2(n) are at a high level, the first scanning signal terminal Gate1(n), the first light-emitting control signal terminal EM1(n) and the second scanning signal terminal Gate2(n) are at a low level, the second reset transistor T7 is turned on, and the first electrode of the sub-pixel L0 is reset; the first light-emitting control transistor T5, the driving transistor T3 and the compensation transistor T2 are turned on, the first power supply terminal VDD is connected to the first node N1, and in a case where the potential VN1 of the first node N1 is written as [Vdd+Vth (T3)], the driving transistor T3 is turned off, and Vdd is the potential of the first power supply terminal VDD; the data writing transistor T4 remains on, and the potential VN2 of the second node N2 remains at VH.

As shown in FIGS. 2 and 3(a), in the data writing phase S3, the potential of the data signal terminal Data changes from the first voltage (denoted as VH) to the second voltage (denoted as VL), the first reset signal terminal Gate1(n−1), the first scanning signal terminal Gate1(n), the first light-emitting control signal terminal EM1(n), and the second light-emitting control signal terminal EM2(n) are at a high level, the second scanning signal terminal Gate2(n) is at a low level, the data writing transistor T4 is turned on, and the data signal terminal Data inputs the second voltage (i.e., VL) to the second node N2, i.e., the potential VN2 of the second node N2 changes from VH to VL. Due to the coupling effect of the first capacitor C1, the potential VN1 of the first node N1 also changes, which is shown in the following in detail:

VN1=Vdd+Vth+ΔV*C1/(C1+C2);
here, Vth is the threshold voltage of the driving transistor, ΔV is an amount of change in potential of the data signal terminal Data from VH to VL, i.e., ΔV=VL-VH.

As shown in FIGS. 2 and 3(a), in the light-emitting phase S4, the first reset signal terminal Gate1(n−1), the first scanning signal terminal Gate1(n) and the second scanning signal terminal Gate2(n) are at a high level, the first light-emitting control signal terminal EM1(n) and the second light-emitting control signal terminal EM2(n) are at a low level, the first light-emitting control transistor T5 and the second light-emitting control transistor T6 are turned on, and the sub-pixel L0 emits light.

In the light-emitting phase S4, the gate-source voltage Vgs of the driving transistor T3 is expressed as: Vgs=VN1−Vdd=Vth+ΔV*C1/(C1+C2); the driving transistor T3 operates in a saturation region, and the calculation formula of its light-emitting current loled is expressed as:

$$Ioled = \frac{k}{2} {( Vgs - Vth )}^{2} = \frac{k}{2} {( Δ V \times \frac{C 1}{C 1 + C 2} )}^{2} ;$$

here, k=μ*Cox*(W/L), μ is the mobility of the driving transistor T3, Cox is a gate oxide layer capacitance, and W/L is a width-to-length ratio of a channel of the driving transistor T3. As can be seen from the calculation formula of loled that, the value of loled is independent of the potential (Vdd) of the first power supply terminal VDD and the threshold voltage (Vth) of the driving transistor T3. Therefore, compensation is achieved for the potential (Vdd) of the first power supply terminal VDD and the threshold voltage (Vth) of the driving transistor T3, which may bring good display uniformity.

The operation process of the pixel circuit in FIG. 2 will be described in detail below in conjunction with the operation timing diagram of the pixel circuit shown in FIG. 3(b) by taking an example in which the above-mentioned transistors as P-type transistors and the operating level is a low level.

As shown in FIGS. 2 and 3(b), in an initialization phase S1, the first scanning signal terminal Gate1(n), the first light-emitting control signal terminal EM1(n) and the second light-emitting control signal terminal EM2(n) are at a high level, the first reset signal terminal Gate1(n−1) and the second scanning signal terminal Gate2(n) are at a low level, the first reset transistor T1 is turned on, the potential VN1 of the first node N1 is written as Vinit1 by the first initialization signal terminal Init1, the data writing transistor T4 is turned on, and the data signal terminal Data inputs a first voltage (denoted as VH) to the second node N2, that is, the potential VN2 of the second node N2 is written as VH by the data signal terminal Data; the voltages at the two ends of the first capacitor C1 are reset.

As shown in FIGS. 2 and 3(b), in the compensation phase S2, the first reset signal terminal Gate1(n−1) and the second light-emitting control signal terminal EM2(n) are at a high level, the first scanning signal terminal Gate1(n), the first light-emitting control signal terminal EM1(n) and the second scanning signal terminal Gate2(n) are at a low level, the second reset transistor T7 is turned on, the first electrode of the sub-pixel L0 is reset, the first light-emitting control transistor T5, the driving transistor T3 and the compensation transistor T2 are turned on, the first power supply terminal VDD is connected to the first node N1, and in a case where the potential VN1 of the first node N1 is written as [VDD+Vth (T3)], the driving transistor T3 is turned off; the data writing transistor T4 remains on, and the potential VN2 of the second node N2 remains at VH. It can be seen that, compared with the timing diagram shown in FIG. 3(a), the operation process of the pixel circuit in the initialization phase S1 and the compensation phase S2 in the timing diagram shown in FIG. 3(b) are consistent with that in FIG. 3(a).

As shown in FIGS. 2 and 3(b), in the data writing phase S3, in a case of t0<Time t< (t0+T), the potential of the data signal terminal Data changes from the first voltage (VH) to the second voltage (VL), the second scanning signal terminal Gate2(n) is at a low level, and the data writing transistor T4 is turned on; at Time t0, the data signal terminal Data inputs the second voltage (VL) to the second node N2, that is, the potential VN2 of the second node N2 changes from VH to VL. Due to the coupling effect of the first capacitor C1, the potential VN1(t0) of the first node N1 at Time to also changes, which is shown in the following in detail:

VN1(t0)=Vdd+Vth+ΔV*C1/(C1+C2)

At Time t0, the gate-source voltage Vgs of the driving transistor T3 is expressed as:

Vgs(t0)=VN1(t0)−Vdd=Vth+ΔV*C1/(C1+C2) Formula 1

Here, ΔV is the amount of change in the potential of the data signal terminal Data from VH to VL, that is, ΔV=VL−VH.

In a case of t0<Time t<(t0+T), the first scanning signal terminal Gate1(n) and the first light-emitting control signal terminal EM1(n) remain low, and the first power terminal VDD continues to charge the first node N1. The first period mentioned above is a period from Time t0 to Time (t0+T).

At Time (t0+T), since the first power supply terminal VDD continues to charge the first node N1 during a time interval T, the potential VN1(t0+T) of the first node N1 at Time (t0+T) increases by ΔW compared to VN1(t0), which is shown in the following in detail:

VN1(t0+T)=VN1(t0)+ΔW=Vdd+Vth+ΔV*C1/(C1+C2)+ΔW

At Time (t0+T), the gate-source voltage Vgs of the driving transistor T3 is:

Vgs(t0+T)=VN(t0+T)−Vdd=Vth+ΔV*C1/(C1+C2)+ΔW Formula 2

It can be seen from Formula 1 and Formula 2 that:

ΔW=VN1(t0+T)−VN1(t0)=Vgs(t0+T)−Vgs(t0) Formula 3

According to the law of charge conservation, the following formula can be obtained:

$$( C 1 + C 2 ) \frac{dVgs}{d t} + \frac{k}{2} {( Vgs - Vth )}^{2} = 0 \qquad Formula 4$$

In Formula 4, k=μ*Cox*(W/L), μ is the mobility of the driving transistor T3, Cox is a gate oxide layer capacitance, and W/L is a width-to-length ratio of the channel of the driving transistor T3.

Formula 4 is integrated, and the following formula is obtained:

$${\int }_{Vgs ( t 0 )}^{Vgs ( t 0 + T )} \frac{- 1}{{( Vgs - Vth )}^{2}} dVgs = {\int }_{t 0}^{t 0 + T} \frac{k}{2 ( C 1 + C 2 )} dt \qquad Formula 5$$

It can be seen from Formula 5 that:

$$Vgs ( t 0 + T ) = Vth + \frac{1}{( \frac{kT}{2 ( C 1 + C 2 )} + \frac{C 1 + C 2}{Δ V * C 1} )} \qquad Formula 6$$

It can be seen from Formula 1, Formula 3, and Formula 6 that:

$$Δ W = \frac{1}{( \frac{kT}{2 ( C 1 + C 2 )} + \frac{C 1 + C 2}{Δ V * C 1} )} - \frac{Δ V * C 1}{C 1 + C 2} ;$$

here, in the data writing phase S3, in a case of Time t>(t0+T), the gate-source voltage of the driving transistor T3 remains unchanged. The second period mentioned above is a period from Time (t0+T) to the end time (Time t1) in the data writing phase S3.

As shown in FIGS. 2 and 3(b), in the light-emitting phase S4, the first reset signal terminal Gate1(n−1), the first scanning signal terminal Gate1(n) and the second scanning signal terminal Gate2(n) are at a high level, the first light-emitting control signal terminal EM1(n) and the second light-emitting control signal terminal EM2(n) are at a low level, the first light-emitting control transistor T5 and the second light-emitting control transistor T6 are turned on, and the sub-pixel L0 emits light.

In the light-emitting phase S4, the gate-source voltage of the driving transistor T3 is expressed as:

$$Vgs = Vgs ( t 0 + T ) = Vth = \frac{1}{( \frac{kT}{2 ( C 1 + C 2 )} + \frac{C 1 + C 2}{Δ V * C 1} )} \qquad Formula 7$$

The driving transistor T3 operates in the saturation region, and the calculation formula of its light-emitting current loled is expressed as:

$$\begin{matrix}Ioled = \frac{k}{2} {( Vgs - Vth )}^{2} \\ = \frac{k}{2} {( \frac{1}{( \frac{kT}{2 ( C 1 + C 2 )} ) + \frac{C 1 + C 2}{Δ V * C 1}} )}^{2}\end{matrix} \qquad Formula 8$$

In the related art, in a case where the mobility drifts, the value of the light-emitting current will change. For example, in a case where the mobility increases, the light-emitting current will increase. In the embodiments of the present disclosure, it can be seen from Formula 7 and the calculation formula of the light-emitting current loled that, in the case where the mobility increases, the gate-source voltage Vgs of the driving transistor T3 will decrease, thereby suppressing the increase of loled to achieve compensation for the mobility drift. By adjusting the magnitude of the time T, the compensation effect may be adjusted. Moreover, the value of loled is independent of the potential (Vdd) of the first power supply terminal VDD and the threshold voltage (Vth) of the driving transistor T3, thereby achieving compensation for the potential (Vdd) of the first power supply terminal VDD and the threshold voltage (Vth) of the driving transistor T3, which may bring good display uniformity.

The operation process of the pixel circuit in FIG. 2 is described in detail in conjunction with the operation timing diagram of the pixel circuit shown in FIG. 3(c) by taking an example in which the above-mentioned transistors are P-type transistors and the operating level is a low level. Compared with the timing diagram shown in FIG. 3(b), the operation process of the pixel circuit in the initialization phase S1 in the timing diagram shown in FIG. 3(c) is consistent with that in FIG. 3(b), the operation process of the pixel circuit in the compensation phase S2 in the timing diagram shown in FIG. 3(c) is consistent with that in FIG. 3(b), and the operation process of the pixel circuit in the first period [from Time t0 to Time (t0+T)] in the data writing phase S3 is consistent with that in FIG. 3(b). In the second period [from Time (t0+T) to Time t1] of the data writing phase S3, the first light-emitting control signal terminal EM1(n) is at a low level, the first power supply terminal VDD is connected to the first electrode of the driving transistor T3, and the gate-source voltage of the driving transistor T3 is as shown in the above Formula 6. In addition, in the timing diagram shown in FIG. 3(c), the operation process of the pixel circuit in the light emitting phase S4 is consistent with that in FIG. 3(b), and the calculation formula of the light-emitting current is as shown in the above Formula 8.

The operation process of the pixel circuit in FIG. 4 is described in detail with reference to the operation timing diagram shown in FIG. 5 by taking an example in which the above-mentioned transistors as P-type transistors, and the operating level is a low level. Compared with the pixel circuit shown in FIG. 2, in the pixel circuit shown in FIG. 4, the control electrode of the first light-emitting control transistor T5 is connected to the auxiliary control signal terminal EM(n−1), and the control electrode of the second light-emitting control transistor T6 is connected to the light-emitting control signal terminal EM(n). The operation process of the pixel circuit shown in FIG. 4 is substantially the same as the operation process [operating according to the operation timing diagram shown in FIG. 3(b)] of the pixel circuit shown in FIG. 2, with the only difference being that: in the initialization phase S1, the auxiliary control signal terminal EM(n−1) is at a high level, the light-emitting control signal terminal EM(n) is at a low level, and the second light-emitting control transistor T6 is turned on; in the compensation phase S2, the auxiliary control signal terminal EM(n−1) is at a low level, the light-emitting control signal terminal EM(n) is at a high level, and the first light-emitting control transistor T5 is turned on; in the data writing phase S3, the auxiliary control signal terminal EM(n−1) is at a low level, the light-emitting control signal terminal EM(n) is at a high level, and the first light-emitting control transistor T5 remains turned on; in the light-emitting phase S4, the auxiliary control signal terminal EM(n−1) and the light-emitting control signal terminal EM(n) are both at a low level, the first light-emitting control transistor T5 and the second light-emitting control transistor T6 are both turned on, and the calculation formula of light-emitting current is as shown in the above-mentioned Formula 8.

The operation process of the pixel circuit in FIG. 6 is described in detail with reference to the operation timing diagram shown in FIG. 7 by taking an example in which the above-mentioned transistors as P-type transistors and the operating level is a low level. Compared with the pixel circuit shown in FIG. 4, the pixel circuit shown in FIG. 6 does not include the first light-emitting control transistor T5. The operation process of the pixel circuit shown in FIG. 6 is substantially the same as the operation process [operating according to the operation timing diagram shown in FIG. 5] of the pixel circuit shown in FIG. 4, with the only difference being that: in the initialization phase S1, the light-emitting control signal terminal EM(n) is at a high level, and the second light-emitting control transistor T6 is turned off. The calculation formula of the light-emitting current of the sub-pixel L0 in the pixel circuit shown in FIG. 6 is as shown in the above-mentioned Formula 8.

The operation process of the pixel circuit in FIG. 8 is described in detail with reference to the operation timing diagram shown in FIG. 9 by taking an example in which the above-mentioned transistors are N-type transistors and the operating level is a high level. The operation process of the pixel circuit shown in FIG. 8 is substantially the same as the operation process [operating according to the operation timing diagram shown in FIG. 3(b)] of the pixel circuit shown in FIG. 2, with the only difference being that: in the case where the compensation transistor T2 is turned on, the first node N1 is connected to the third node N3. The calculation formula of the light-emitting current loled of the sub-pixel L0 in the pixel circuit shown in FIG. 8 is as shown in the above Formula 8. In addition, in FIG. 9, the first voltage is VL and the second voltage is VH.

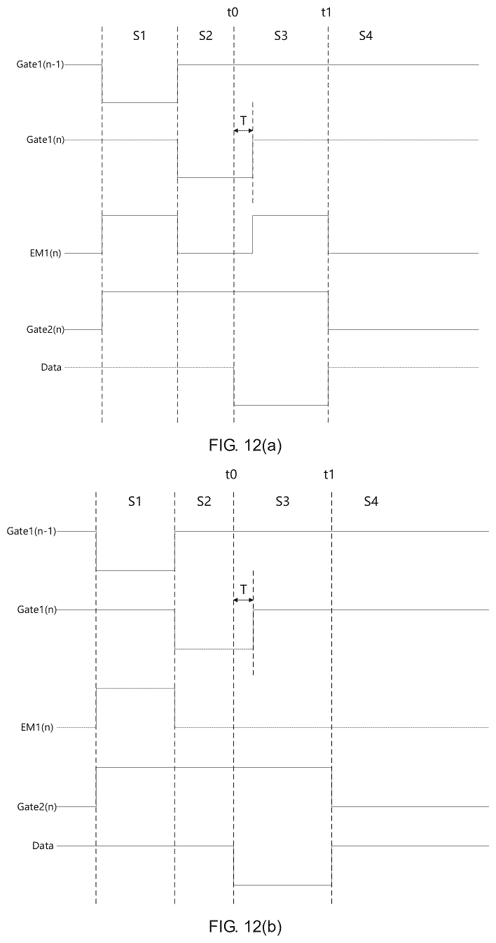

The operation process of the pixel circuit in FIG. 11 is described in detail below in conjunction with the operation timing diagram of the pixel circuit shown in FIG. 12(a). Here, the data writing transistor T4 is an N-type transistor, and the operating level is a high level. The data writing transistor T4 is an oxide transistor, which may prevent the data writing transistor T4 from leaking, thereby preventing the first node N1 from jumping. Moreover, the other transistors are P-type transistors, and the operating level is a low level.

As shown in FIGS. 11 and 12(a), in the initialization phase S1, the first scanning signal terminal Gate1(n), the first light-emitting control signal terminal EM1(n) and the second scanning signal terminal Gate2(n) are at a high level; the first reset signal terminal Gate1(n−1) is at a low level, and the first reset transistor T1 is turned on; Thus, the potential VN1 of the first node N1 is written as Vinit1 by the first initialization signal terminal Init1; the data writing transistor T4 is turned on, and the data signal terminal Data inputs the first voltage (VH) to the second node N2, that is, the potential VN2 of the second node N2 is written as VH by the data signal terminal Data; the voltages at two ends of the first capacitor C1 are reset.

As shown in FIGS. 11 and 12(a), in the compensation phase S2, the first reset signal terminal Gate1(n−1) and the second scanning signal terminal Gate2(n) are at a high level, the first scanning signal terminal Gate1(n) and the first light-emitting control signal terminal EM1(n) are at a low level, the second reset transistor T7 is turned on, and the first electrode of the sub-pixel L0 is reset; the first light-emitting control transistor T5, the driving transistor T3 and the compensation transistor T2 are turned on, the first power supply terminal VDD is connected to the first node N1, and in a case where the potential VN1 of the first node N1 is written as [VDD+Vth (T3)], the driving transistor T3 is turned off; the data writing transistor T4 remains on, and the potential VN2 of the second node N2 remains at VH.

As shown in FIGS. 11 and 12(a), in the data writing phase S3, in a case of t0<Time t< (t0+T), the potential of the data signal terminal Data changes from the first voltage (VH) to the second voltage (VL), the second scanning signal terminal Gate2(n) is at a high level, and the data writing transistor T4 is turned on; at Time t0, the data signal terminal Data inputs the second voltage (VL) to the second node N2, that is, the potential VN2 of the second node N2 changes from VH to VL. Due to the coupling effect of the first capacitor C1, the potential VN1(t0) of the first node N1 at Time to also changes, which is shown in the following in detail:

VN1(t0)=Vdd+Vth+ΔV*C1/(C1+C2);

At Time t0, the gate-source voltage Vgs of the driving transistor T3 is expressed as:

Vgs(t0)=VN1(t0)−Vdd=Vth+ΔV*C1/(C1+C2) Formula 1

Here, ΔV is the amount of change in the potential of the data signal terminal Data from VH to VL, i.e., ΔV=VL-VH.

In the case where to <Time t< (t0+T), the first scanning signal terminal Gate1(n) and the first light-emitting control signal terminal EM1(n) remain at a low level, and the first power terminal VDD continues to charge the first node N1. The first period mentioned above is a period between Time to and Time (t0+T).

At Time (t0+T), since the first power supply terminal VDD continues to charge the first node N1 during a time interval T, the potential VN1(t0+T) of the first node N1 at Time (t0+T) increases by ΔW compared to VN1(t0), which is shown in the following in detail:

VN1(t0+T)=VN1(t0)+ΔW=Vdd+Vth+ΔV*C1/(C1+C2)+ΔW

At Time (t0+T), the gate-source voltage Vgs of the driving transistor T3 is expressed as:

Vgs(t0+T)=VN(t0+T)−Vdd=Vth+ΔV*C1/(C1+C2)+ΔW Formula2

It can be seen from Formula 1 and Formula 2 that:

ΔW=VN1(t0+T)−VN1(t0)=Vgs(t0+T)−Vgs(t0) Formula 3

According to the law of charge conservation, the following formula can be obtained:

$$( C 1 + C 2 ) \frac{dVgs}{dt} + \frac{k}{2} {( Vgs - Vth )}^{2} = 0 \qquad Formula 4$$

In Formula 4, k=μ*Cox*(W/L), μ is the mobility of the driving transistor T3, Cox is the gate oxide layer capacitance, W/L is the width-to-length ratio of the channel of the driving transistor T3, and Vth is the threshold voltage of the driving transistor T3.

Formula 4 is integrated, the following formula is obtained:

$${\int }_{Vgs ( t 0 )}^{Vgs ( t 0 + T )} \frac{- 1}{{( Vgs - Vth )}^{2}} dVgs = {\int }_{t 0}^{t 0 + T} \frac{k}{2 ( C 1 + C 2 )} dt \qquad Formula 5$$

It can be seen from Formula 5 that:

$$Vgs ( t 0 + T ) = Vth + \frac{1}{( \frac{kT}{2 ( C 1 + C 2 )} + \frac{C 1 + C 2}{Δ V * C 1} )} \qquad Formula 6$$

It can be seen from Formula 1, Formula 3, and Formula 6 that:

$$Δ W = \frac{1}{( \frac{kT}{2 ( C 1 + C 2 )} + \frac{C 1 + C 2}{Δ V * C 1} )} - \frac{Δ V * C 1}{C 1 + C 2}$$

Here, in the data writing phase S3, in a case of Time t>(t0+T), the gate-source voltage of the driving transistor T3 remains unchanged. The second period mentioned above is a period from Time (t0+T) to the end time (Time t1) in the data writing phase S3.

As shown in FIGS. 11 and 12(a), in the light-emitting phase S4, the first reset signal terminal Gate1(n−1) and the first scanning signal terminal Gate1(n) are at a high level, the second scanning signal terminal Gate2(n) and the first light-emitting control signal terminal EM1(n) are at a low level, the first light-emitting control transistor T5 and the second light-emitting control transistor T6 are turned on, and the sub-pixel L0 emits light.

In the light-emitting phase S4, the gate-source voltage of the driving transistor T3 is expressed as:

$$Vgs = Vgs ( t 0 + T ) = Vth = \frac{1}{( \frac{kT}{2 ( C 1 + C 2 )} + \frac{C 1 + C 2}{Δ V * C 1} )} \qquad Formula 7$$

The driving transistor T3 operates in the saturation region, and the calculation formula of its light-emitting current loled is expressed as:

$$\begin{matrix}Ioled = \frac{k}{2} {( Vgs - Vth )}^{2} \\ = \frac{k}{2} {( \frac{1}{( \frac{kT}{2 ( C 1 + C 2 )} ) + \frac{C 1 + C 2}{Δ V * C 1}} )}^{2}\end{matrix} \qquad Formula 8$$

In the related art, in a case where the mobility drifts, the value of the light-emitting current will change. For example, in a case where the mobility increases, the light-emitting current will increase. In the embodiments of the present disclosure, it can be seen from Formula 7 and the calculation formula of the light-emitting current loled that, in the case where the mobility increases, the gate-source voltage Vgs of the driving transistor T3 will decrease, thereby suppressing the increase of loled to achieve compensation for the mobility drift. By adjusting the magnitude of the time T, the compensation effect may be adjusted. Moreover, the value of loled is independent of the potential (Vdd) of the first power supply terminal VDD and the threshold voltage (Vth) of the driving transistor T3, thereby achieving compensation for the potential (Vdd) of the first power supply terminal VDD and the threshold voltage (Vth) of the driving transistor T3, which may bring good display uniformity.

The operation process of the pixel circuit in FIG. 11 is described in detail in conjunction with the operation timing diagram of the pixel circuit shown in FIG. 12(b). Here, the data writing transistor T4 is an N-type transistor, the operating level is a high level, and the data writing transistor T4 is an oxide transistor, which may prevent the data writing transistor T4 from leaking, thereby preventing the first node N1 from jumping. The other transistors are P-type transistors, and the operating level is a low level. Compared with the timing diagram shown in FIG. 12(a), the operation process of the pixel circuit in the initialization phase S1 in the timing diagram shown in FIG. 12(b) is consistent with that in FIG. 12(a), the operation process of the pixel circuit in the compensation phase S2 in the timing diagram shown in FIG. 12(b) is consistent with that in FIG. 12(a), and the operation process of the pixel circuit in the first period [from Time t0 to Time (t0+T)] in the data writing phase S3 in the timing diagram shown in FIG. 12(b) is consistent with that in FIG. 12(a). In the second period of the data writing phase S3 [from Time (t0+T) to Time t1], the first light-emitting control signal terminal EM1(n) is at a low level, the first power supply terminal VDD is connected to the first electrode of the driving transistor T3, and the gate-source voltage of the driving transistor T3 is as shown in the above Formula 6. In addition, the operation process of the pixel circuit in the light-emitting phase S4 in the timing diagram shown in FIG. 12(b) is consistent with that in FIG. 12(a), and the calculation formula of the light-emitting current is as shown in the above Formula 8.

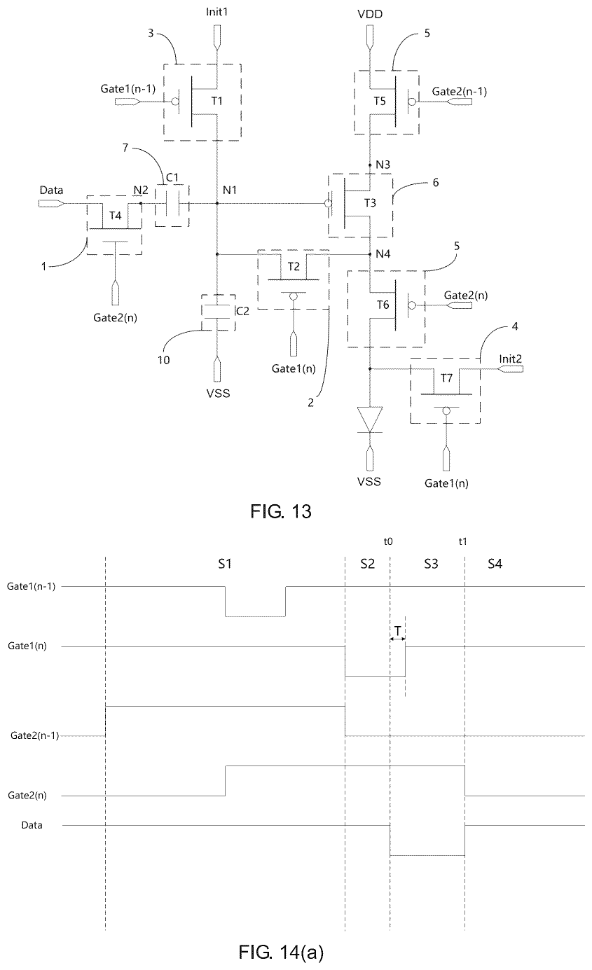

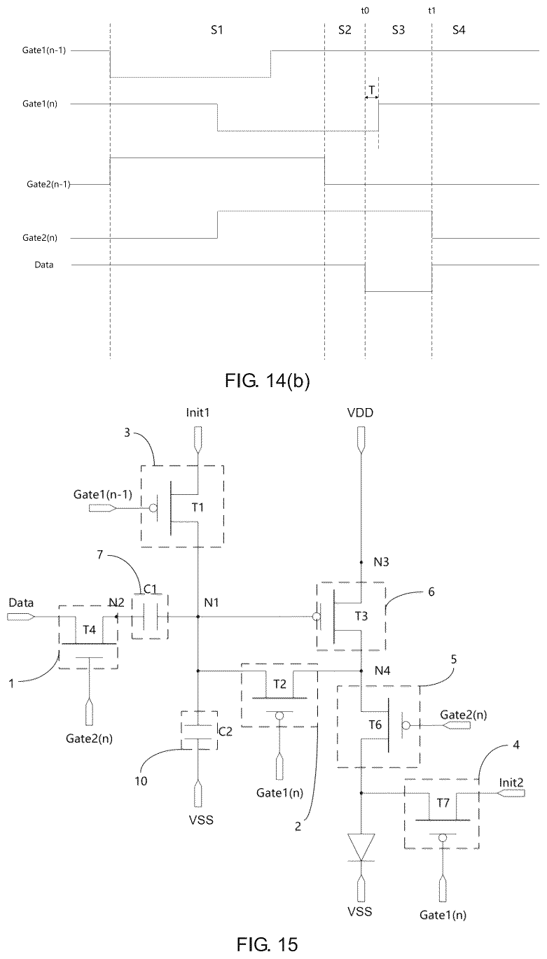

The operation process of the pixel circuit in FIG. 13 is described in detail in conjunction with the operation timing diagram shown in FIG. 14(a). The data writing transistor T4 is an N-type transistor, the operating level is a high level, and the data writing transistor T4 is an oxide transistor, which may prevent the data writing transistor T4 from leaking, thereby preventing the first node N1 from jumping. The other transistors are P-type transistors, and the operating level is a low level. Compared with the pixel circuit shown in FIG. 11, in the pixel circuit shown in FIG. 13, the control electrode of the first light-emitting control transistor T5 is connected to the third scanning signal terminal Gate2(n−1), and the control electrode of the second light-emitting control transistor T6 is connected to the second scanning signal terminal Gate2(n). The operation process of the pixel circuit shown in FIG. 13 is substantially the same as the operation process (operating according to the operation timing diagram shown in FIG. 12(a)) of the pixel circuit shown in FIG. 11, with the difference being that: the initialization phase S1 includes three periods. Period 1: the first reset signal terminal Gate1(n−1), the first scanning signal terminal Gate1(n), and the third scanning signal terminal Gate2(n−1) are at a high level, and transistors T1, T2, T5, and T7 are turned off; the second scanning signal terminal Gate2(n) is at a low level, and the transistor T4 is turned off, and the transistor T6 remains the on state that is in the previous frame. Second period: the first reset signal terminal Gate1(n−1) is at a low level, the transistor T1 is turned on, the potential VN1 of the first node N1 is written as Vinit1 by the first initialization signal terminal Init1, the data writing transistor T4 is turned on, and the data signal terminal Data inputs the first voltage (VH) to the second node N2, that is, the potential VN2 of the second node N2 is written as VH by the data signal terminal Data; the voltages at two ends of the first capacitor C1 are reset. Period 3: the first reset signal terminal Gate1(n−1), the first scanning signal terminal Gate1(n), the third scanning signal terminal Gate2(n−1) and the second scanning signal terminal Gate2(n) are at a high level, the transistors T1, T2, T5, T6 and T7 are turned off, and the transistor T4 is turned on; the voltages of the first node N1 and the second node N2 remain unchanged. The operating principles of the compensation phase S2, the data writing phase S3 and the light-emitting phase S4 are substantially the same as the operation timing diagram shown in FIG. 12(a), and the calculation formula of the light-emitting current is the same as the above Formula 8.

The operation process of the pixel circuit in FIG. 13 is described in detail in conjunction with the operation timing diagram shown in FIG. 14(b). The data writing transistor T4 is an N-type transistor, the operating level is a high level, and the data writing transistor T4 is an oxide transistor, which may prevent the data writing transistor T4 from leaking, thereby preventing the first node N1 from jumping. The other transistors are P-type transistors, and the operating level is a low level. The operation process of the pixel circuit shown in FIG. 13 is substantially the same as the operation process (operating according to the operation timing diagram shown in FIG. 12(a)) of the pixel circuit shown in FIG. 11, with the difference being that: the initialization phase S1 includes three periods. Period 1: the first scanning signal terminal Gate1(n) and the third scanning signal terminal Gate2(n−1) are at a high level, the transistors T2, T4, T5, and T7 are turned off, the first reset signal terminal Gate1(n−1) and the second scanning signal terminal Gate2(n) are at a low level, the transistor T1 is turned on, and the transistor T6 remains in the an state that is in the previous frame. The potential VN1 of the first node N1 is written as Vinit1 by the first initialization signal terminal Init1. Second period: the first reset signal terminal Gate1(n−1) and the first scanning signal terminal Gate1(n) are at a low level, and the transistors T1, T2, and T7 are turned on; the third scanning signal terminal Gate2(n−1) and the second scanning signal terminal Gate2(n) are at a high level, the transistors T5 and T6 are turned off, and the transistor T4 is turned on; the data signal terminal Data inputs the first voltage (VH) to the second node N2, that is, the potential VN2 of the second node N2 is written as VH by the data signal terminal Data; the anode of the sub-pixel L0 is written as Vinit2 by the second initialization signal terminal Init2. Period 3: the third scanning signal terminal Gate2(n−1), the first reset signal terminal Gate1(n−1) and the second scanning signal terminal Gate2(n) are at high level, and the transistors T1, T5 and T6 are turned off; the first scanning signal terminal Gate1(n) is at a low level, and the transistors T2 and T7 remain in an on state; the operating principles of the compensation phase S2, the data writing phase S3 and the light-emitting phase S4 are substantially the same as the operating timing diagram shown in FIG. 12(a), and the calculation formula of the light-emitting current is the same as the above Formula 8.

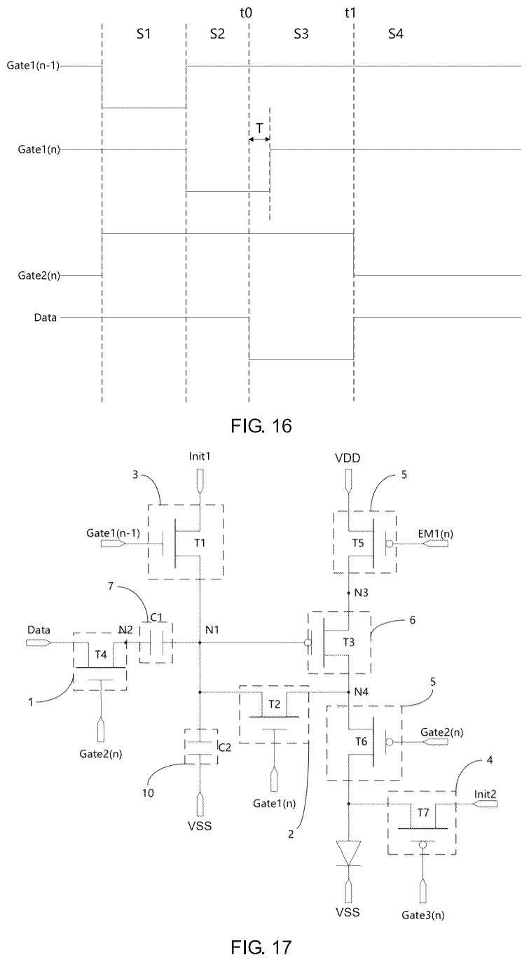

The operation process of the pixel circuit in FIG. 15 is described in detail in conjunction with the operation timing diagram shown in FIG. 16. The data writing transistor T4 is an N-type transistor, the operating level is a high level, and the data writing transistor T4 is an oxide transistor, which may prevent the data writing transistor T4 from leaking, thereby preventing the first node N1 from jumping. The other transistors are P-type transistors, and the operating level is a low level. The operation process of the pixel circuit shown in FIG. 15 is substantially the same as the operation process [operating according to the operation timing diagram shown in FIG. 12(a)] of the pixel circuit shown in FIG. 11, with the difference being that: the first light-emitting control transistor T5 is not provided in the pixel circuit shown in FIG. 15. The calculation formula of the light-emitting current of the sub-pixel L0 in the pixel circuit shown in FIG. 15 is as shown in the above-mentioned Formula 8.

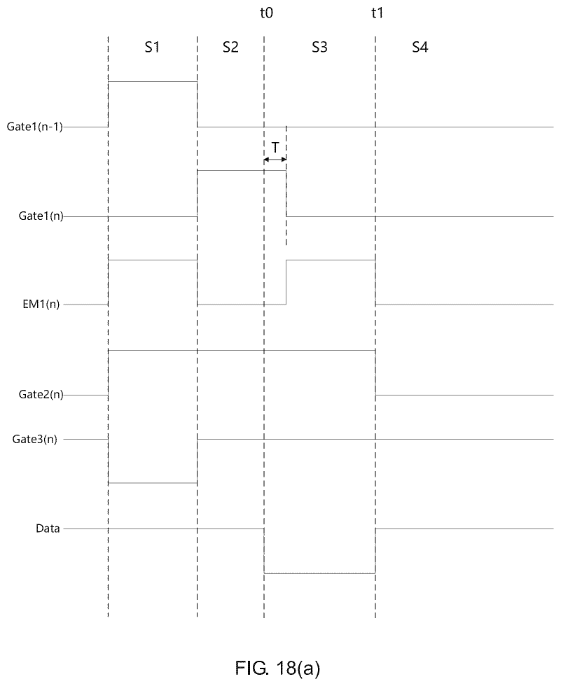

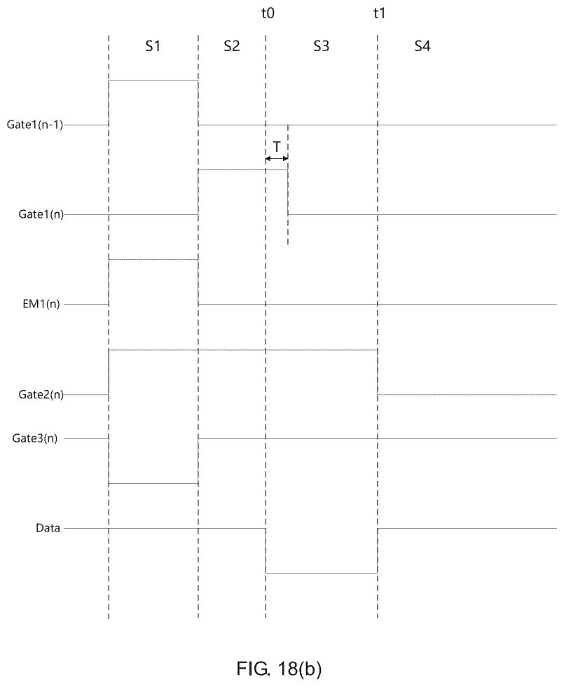

The operation process of the pixel circuit in FIG. 17 is described in detail in conjunction with the operation timing diagram shown in FIG. 18(a). The first reset transistor T1, the compensation transistor T2, and the data writing transistor T4 are N-type transistors and the operating level is a high level, and the first reset transistor T1, the compensation transistor T2, and the data writing transistor T4 are oxide transistors, which may prevent the transistors from leaking, thereby preventing the first node N1 from jumping. The other transistors are P-type transistors, and the operating level is a low level. The operation process of the pixel circuit shown in FIG. 17 is substantially the same as the operation process [operating according to the operation timing diagram shown in FIG. 12(a)] of the pixel circuit shown in FIG. 11, with the difference being that: the control electrode of the second reset transistor T7 is connected to the second reset signal terminal Gate3(n). The second reset signal terminal Gate3(n) is at a low level in the initialization phase S1 and is at a high level in other phases; the potentials of the control electrodes of the first reset transistor T1 and compensation transistor T2 in their corresponding on and off phases are opposite to the potentials shown in the operation timing diagram shown in FIG. 12(a). The calculation formula of the light-emitting current loled of the sub-pixel L0 in the pixel circuit shown in FIG. 17 is as shown in the above-mentioned Formula 8.

The operation process of the pixel circuit in FIG. 17 is described in detail in conjunction with the operation timing diagram shown in FIG. 18(b). The first reset transistor T1, the compensation transistor T2, and the data writing transistor T4 are N-type transistors, the operating level is a high level, and the first reset transistor T1, the compensation transistor T2, and the data writing transistor T4 are oxide transistors, which may prevent the transistors from leaking, thereby preventing the first node N1 from jumping. The other transistors are P-type transistors, and the operating level is a low level. The operation process of the pixel circuit shown in FIG. 17 is substantially the same as the operation process [operating according to the operation timing diagram shown in FIG. 12(b)] of the pixel circuit shown in FIG. 11, with the difference being that: the control electrode of the second reset transistor T7 is connected to the second reset signal terminal Gate3(n). The second reset signal terminal Gate3(n) is at a low level in the initialization phase S1 and is at a high level in other phases. The potentials of the control electrodes of the first reset transistor T1 and the compensation transistor T2 in their corresponding on and off phases are opposite to the potentials in the operation timing diagram shown in FIG. 12(b). The calculation formula of the light-emitting current loled of the sub-pixel L0 in the pixel circuit shown in FIG. 17 is as shown in the above-mentioned Formula 8.

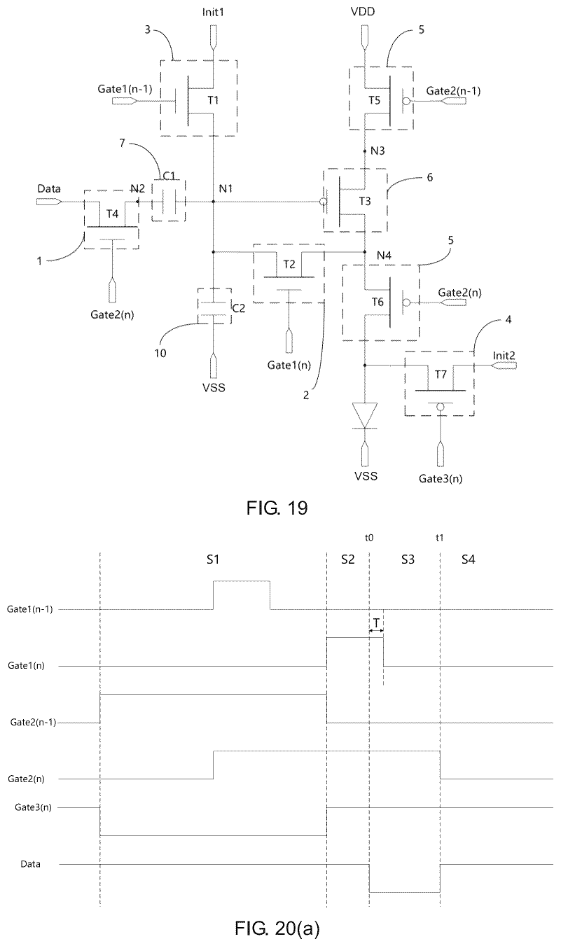

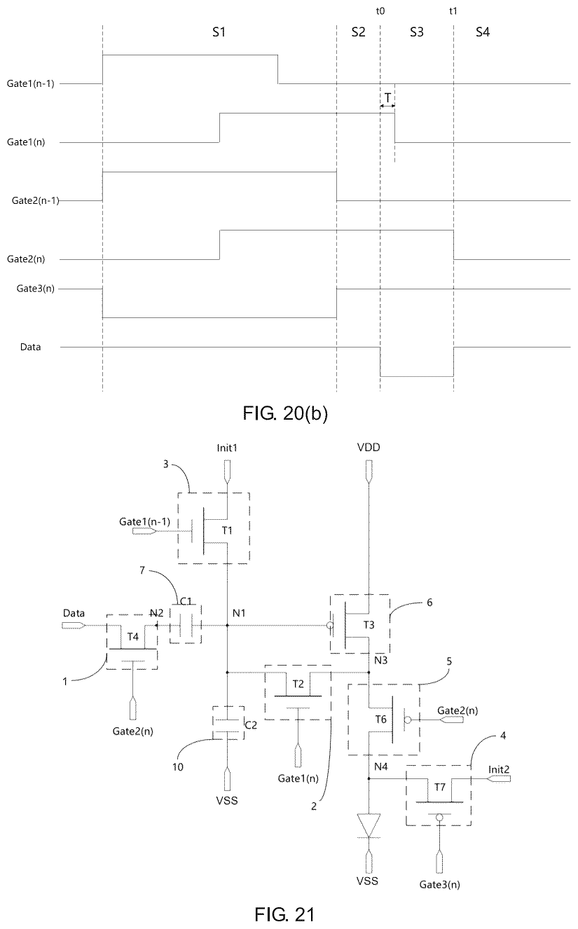

The operation process of the pixel circuit in FIG. 19 is described in detail in conjunction with the operation timing diagram shown in FIG. 20(a). The first reset transistor T1, the compensation transistor T2, and the data writing transistor T4 are N-type transistors, and the operating level is a high level; the first reset transistor T1, the compensation transistor T2, and the data writing transistor T4 are oxide transistors, which may prevent the transistors from leaking, thereby preventing the first node N1 from jumping. The other transistors are P-type transistors, and the operating level is a low level. The operation process of the pixel circuit shown in FIG. 19 is substantially the same as the operation process [operating according to the operation timing diagram shown in FIG. 14(a)] of the pixel circuit shown in FIG. 13, with the difference that: the control electrode of the second reset transistor T7 is connected to the second reset signal terminal Gate3(n). The second reset signal terminal Gate3(n) is at a low level in the initialization phase S1 and is at a high level in other phases. The potentials of the control electrodes of the first reset transistor T1 and the compensation transistor T2 in their corresponding on and off phases are opposite to the potentials in the operation timing diagram shown in FIG. 14(a). The calculation formula of the light-emitting current loled of the sub-pixel L0 in the pixel circuit shown in FIG. 19 is as shown in the above-mentioned Formula 8.

The operation process of the pixel circuit in FIG. 19 is described in detail in conjunction with the operation timing diagram shown in FIG. 20(b). The first reset transistor T1, the compensation transistor T2, and the data writing transistor T4 are N-type transistors, and the operating level is a high level; the first reset transistor T1, the compensation transistor T2, and the data writing transistor T4 are oxide transistors, which may prevent the transistors from leaking, thereby preventing the first node N1 from jumping. The other transistors are P-type transistors, and the operating level is a low level. The operation process of the pixel circuit shown in FIG. 19 is substantially the same as the operation process [operating according to the operation timing diagram shown in FIG. 14(b)] of the pixel circuit shown in FIG. 13, with the difference being that the control electrode of the second reset transistor T7 is connected to the second reset signal terminal Gate3(n). The second reset signal terminal Gate3(n) is at a low level in the initialization phase S1 and at a high level in other phases. The potentials of the control electrodes of the first reset transistor T1 and the compensation transistor T2 in their corresponding on and off phases are opposite to the potentials in the operation timing diagram shown in FIG. 14(b). The calculation formula of the light-emitting current loled of the sub-pixel L0 in the pixel circuit shown in FIG. 19 is as shown in the above-mentioned Formula 8.

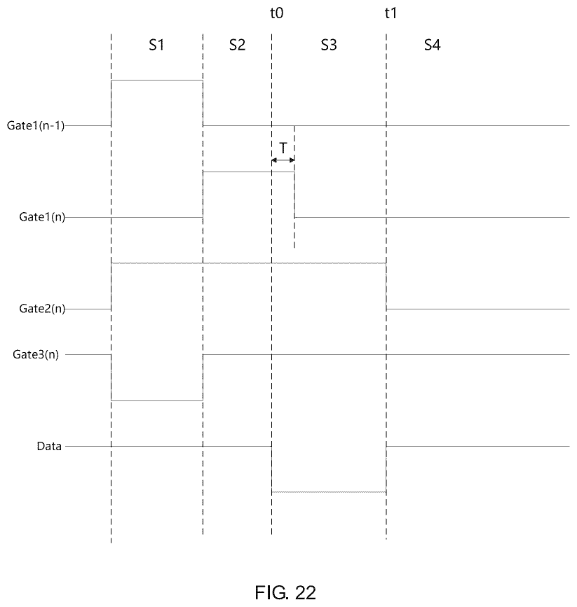

The operation process of the pixel circuit in FIG. 21 is described in detail in conjunction with the operation timing diagram shown in FIG. 22. The first reset transistor T1, the compensation transistor T2 and the data writing transistor T4 are N-type transistors, and the operating level is a high level; the first reset transistor T1, the compensation transistor T2 and the data write transistor T4 are oxide transistors, which may prevent the transistor from leaking, thereby preventing the first node N1 from jumping. The other transistors are P-type transistors, and the operating level is a low level. The operation process of the pixel circuit shown in FIG. 21 is substantially the same as the operation process [operating according to the operation timing diagram shown in FIG. 16] of the pixel circuit shown in FIG. 15, with the difference being that the control electrode of the second reset transistor T7 is connected to the second reset signal terminal Gate3(n). The second reset signal terminal Gate3(n) is at a low level in the initialization phase S1 and is at a high level in other phases. The potentials of the control electrodes of the first reset transistor T1 and the compensation transistor T2 in their corresponding on and off phases are opposite to the potentials in the operation timing diagram shown in FIG. 16. The calculation formula of the light-emitting current loled of the sub-pixel L0 in the pixel circuit shown in FIG. 19 is as shown in the above-mentioned Formula 8.

The embodiments of the present disclosure provide a driving method for a pixel circuit, which is used in the pixel circuit as described in the above embodiments. The driving method for the pixel circuit may include: enabling the driving sub-circuit 6 to control connection or disconnection between the third node N3 and the fourth node N4 under control of the first node N1; enabling the light-emitting control sub-circuit 5 to control connection or disconnection between the fourth node N4 and the first electrode of the sub-pixel L0; enabling the second storage sub-circuit 10 to store the potential of the first node N1; and enabling the data writing sub-circuit 1 to input a voltage to the second node N2; and enabling the compensation sub-circuit 2 to control connection or disconnection between the first node N1 and the third node N3 under the control of the first scanning signal terminal Gate1(n), or enabling the compensation sub-circuit 2 to control connection or disconnection between the first node N1 and the fourth node N4 under the control of the first scanning signal terminal Gate1(n). Since the pixel circuit driven by the driving method for the embodiments of the present disclosure is the same as the pixel circuit in the above embodiments, the driving method has the same beneficial effects and details are not repeated here.

The embodiments of the present disclosure provide a display apparatus. The display apparatus may include any one of the pixel circuit in any one of the above embodiments and a sub-pixel L0 connected to the pixel circuit. The display apparatus may be any product or component with a display function, such as a portable phone, a smart phone, a video phone, a smart tablet, a smart watch, a tablet personal computer, a vehicle navigation system, a television, a computer monitor, a notebook computer, or a head-mounted display. Since the pixel circuit in the display apparatus provided by the embodiments of the present disclosure is the same as the pixel circuit in the above embodiments, the display apparatus has the same beneficial effects, and details are not repeated here.

The above is merely a preferred implementation of the present disclosure and does not constitute any form of limitation to the present disclosure. Although the present disclosure has been disclosed as a preferred implementation as above, it is not intended to limit the present disclosure. Any technician familiar with this profession can make some changes or modifications to equivalent embodiments of the technical content disclosed above without departing from the scope of the technical solution of the present disclosure. However, any simple modifications, equivalent changes and modifications made to the above embodiments based on the technical essence of the present disclosure without departing from the content of the technical solution of the present disclosure are still within the scope of the technical solution of the present disclosure.

What is claimed is:

1. A pixel circuit, used for a display apparatus, wherein the pixel circuit comprises:
a first storage sub-circuit connected between a first node and a second node;
a driving sub-circuit connected to the first node, a third node, and a fourth node, and configured to control connection or disconnection between the third node and the fourth node under control of the first node; the third node being connected to a first power supply terminal;
a light-emitting control sub-circuit connected to the fourth node, and configured to be connected to a first electrode of a sub-pixel, wherein the light-emitting control sub-circuit is used to control connection or disconnection between the fourth node and the first electrode of the sub-pixel;
a second storage sub-circuit connected to the first node and used to store a potential of the first node;
a data writing sub-circuit connected to the second node and used to input a voltage to the second node; and
a compensation sub-circuit connected to a first scanning signal terminal and the first node;
wherein the compensation sub-circuit is further connected to the third node and is used to control connection or disconnection between the first node and the third node under control of the first scanning signal terminal; or
the compensation sub-circuit is further connected to the fourth node and is used to control connection or disconnection between the first node and the fourth node under the control of the first scanning signal terminal.

2. The pixel circuit according to claim 1, wherein in a display frame of a display apparatus, a driving process of the pixel circuit includes a compensation phase and a data writing phase;
in the compensation phase, the compensation sub-circuit is configured to control connection or disconnection between the first node and the third node or fourth node, and the data writing sub-circuit is configured to input a first voltage to the second node;
in the data writing phase, the data writing sub-circuit is configured to input a second voltage to the second node.

3. The pixel circuit according to claim 2, wherein the data writing phase includes a first period and a second period; wherein
in the first period, the compensation sub-circuit is configured to control the first node to be connected to the third node or fourth node, and the data writing sub-circuit is configured to input the second voltage to the second node;
in the second period, the compensation sub-circuit is configured to control the first node to be disconnected from the third node or fourth node, and the data writing sub-circuit is configured to input the second voltage to the second node.

4. The pixel circuit according to claim 1, wherein the pixel circuit further comprises:
a first reset sub-circuit connected to a first reset signal terminal, a first initialization signal terminal and the first node, and is used to control connection or disconnection between the first initialization signal terminal and the first node under control of the first reset signal terminal.

5. The pixel circuit according to claim 4, wherein the first reset sub-circuit includes:
a first reset transistor; a control electrode of the first reset transistor is connected to the first reset signal terminal, a first electrode of the first reset transistor is connected to the first initialization signal terminal, and a second electrode of the first reset transistor is connected to the first node.

6. The pixel circuit according to claim 1, wherein the pixel circuit further comprises:
a second reset sub-circuit connected to the first scanning signal terminal, a second initialization signal terminal and configured to be connected to the first electrode of the sub-pixel, wherein the second reset sub-circuit is used to control connection or disconnection between the second initialization signal terminal and the first electrode of the sub-pixel under the control of the first scanning signal terminal; wherein
the second reset sub-circuit includes:
a second reset transistor; a control electrode of the second reset transistor is connected to the first scanning signal terminal, a first electrode of the second reset transistor is connected to the second initialization signal terminal, and a second electrode of the second reset transistor is configured to be connected to a second electrode of the sub-pixel.

7. The pixel circuit according to claim 1, wherein the data writing sub-circuit includes:
a data writing transistor; a control electrode of the data writing transistor is connected to a second scanning signal terminal, a first electrode of the data writing transistor is connected to a data signal terminal, and a second electrode of the data writing transistor is connected to the second node.

8. The pixel circuit according to claim 1, wherein the driving sub-circuit includes:
a driving transistor, a control electrode of the driving transistor is connected to the first node, a first electrode of the driving transistor is connected to the third node, and a second electrode of the driving transistor is connected to the fourth node.

9. The pixel circuit according to claim 1, wherein the compensation sub-circuit includes:
a compensation transistor; a control electrode of the compensation transistor is connected to the first scanning signal terminal, a first electrode of the compensation transistor is connected to the third node or fourth node, and a second electrode of the compensation transistor is connected to the first node.

10. The pixel circuit according to claim 1, wherein the light-emitting control sub-circuit is further connected to the first power supply terminal and the third node, and is used to control connection or disconnection between the first power supply terminal and the third node.

11. The pixel circuit according to claim 10, wherein the light-emitting control sub-circuit includes a first light-emitting control transistor connected between the first power supply terminal and the third node in series.

12. The pixel circuit according to claim 1, wherein the light-emitting control sub-circuit includes a second light-emitting control transistor connected between the fourth node and the first electrode of the sub-pixel in series.

13. The pixel circuit according to claim 1, wherein the first storage sub-circuit includes a first capacitor; the second storage sub-circuit includes a second capacitor.

14. The pixel circuit according to claim 5, wherein the first reset transistor is an oxide transistor.

15. The pixel circuit according to claim 9, wherein the compensation transistor is an oxide transistor.

16. The pixel circuit according to claim 7, wherein the data writing transistor is an oxide transistor.

17. The pixel circuit according to claim 4, wherein the pixel circuit further comprises a second reset sub-circuit connected to the first scanning signal terminal, and a second initialization signal terminal, and is configured to be connected to the first electrode of the sub-pixel, wherein the second reset sub-circuit is used to control connection or disconnection between the second initialization signal terminal and the first electrode of the sub-pixel under the control of the first scanning signal terminal within a display frame of the display apparatus; wherein
a driving process for the pixel circuit includes:
an initialization phase, wherein the initialization phase includes three periods:
in a first period: the light-emitting control sub-circuit remains in an on state, and the first reset sub-circuit, the data writing sub-circuit, the compensation sub-circuit, and the second reset sub-circuit are turned off;
in a second period: the first reset sub-circuit and the data writing sub-circuit are turned on, the compensation sub-circuit, the light-emitting control sub-circuit, and the second reset sub-circuit are turned off, and the data writing sub-circuit is configured to input the voltage to the second node; and
in a third period: the data writing sub-circuit is turned on, the first reset sub-circuit, the compensation sub-circuit, the light-emitting control sub-circuit, and the second reset sub-circuit are turned off, and voltages of the first node and the second node remain unchanged.

18. The pixel circuit according to claim 4, wherein the pixel circuit further comprises a second reset sub-circuit connected to the first scanning signal terminal, and the second initialization signal terminal, and configured to be connected to the first electrode of the subpixel, wherein the second reset sub-circuit is used to control connection to or disconnection between the second initialization signal terminal and the first electrode of the sub-pixel under the control of the first scanning signal terminal within a display frame of the display apparatus; wherein
a driving process for the pixel circuit further includes:
an initialization phase, wherein the initialization phase includes three periods:
in a first period: the first reset sub-circuit and the light-emitting control sub-circuit remains in an on state, the data writing sub-circuit, the compensation sub-circuit, and the second reset sub-circuit are turned off, and the first reset sub-circuit is configured to reset the first node;
in a second period: the first reset sub-circuit, the data writing sub-circuit, the compensation sub-circuit, and the second reset sub-circuit are turned on, the light-emitting control sub-circuit is turned off, the data writing sub-circuit is configured to input the voltage to the second node, and the second reset sub-circuit is configured to reset the first electrode of the sub-pixel; and
in a third period: the compensation sub-circuit and the second reset sub-circuit are turned on, and the first reset sub-circuit and the light-emitting control sub-circuit are turned off.

19. A driving method for a pixel circuit, wherein the driving method is used for driving the pixel circuit according to claim 1, the driving method comprising:
enabling the driving sub-circuit to control the connection or disconnection between the third node and the fourth node under the control of the first node;
enabling the light-emitting control sub-circuit to control the connection or disconnection between the fourth node and the first electrode of the sub-pixel;
enabling the second storage sub-circuit to store the potential of the first node;
enabling the data writing sub-circuit to input the voltage to the second node; and
enabling the compensation sub-circuit to control the connection or disconnection between the first node and the third node under the control of the first scanning signal terminal, or enabling the compensation sub-circuit to control the connection or disconnection between the first node and the fourth node under the control of the first scanning signal terminal.

20. A display apparatus, wherein the display apparatus comprises: the pixel circuit according to claim 1 and the sub-pixel connected to the pixel circuit.
